(19) United States
(12) Patent Application Publication
(10) Pub. No.: US 2026/0038856 A1
(43) Pub. Date: Feb. 5, 2026

(54) SYSTEMS AND METHODS FOR MULTI-INPUT CATHODE LOOP CONTROL FOR FUEL CELLS

(71) Applicant: Caterpillar Inc., Peoria, IL (US)

(72) Inventors: Shivangi Wagle, Peoria, IL (US); David Andrew Pierpont, Dunlap, IL (US); Anthony Thomas Petrou, Peoria, IL (US)

(73) Assignee: Caterpillar Inc., Peoria, IL (US)

(21) Appl. No.: 18/790,121

(22) Filed: Jul. 31, 2024

(51) Int. Cl. H01M 8/04746; H01M 8/04082; H01M 8/0432; H01M 8/0438; H01M 8/04492

(52) U.S. Cl. CPC H01M 8/04753; H01M 8/04201; H01M 8/0432; H01M 8/04395; H01M 8/0441; H01M 8/04492; H01M 8/04761

(57) ABSTRACT

A fuel cell system may include a turbo compressor, one or more valves, and a controller. The controller may determine a target inlet mass flow and a corresponding pressure ratio of the turbo compressor, determine a desired turbo speed of the turbo compressor, and generate a first drive signal for the turbo compressor, to drive the turbo compressor at the desired turbo speed. As the turbo compressor is driven at the desired turbo speed, the controller may determine an actual inlet mass flow and one or more pressure values relating to the turbo compressor, and generate one or more valve control signals for driving at least one of the valves, to modify an operating condition of the fuel cell system. The controller may generate one or more second drive signals for the turbo compressor, based on the modified operating condition responsive to driving the at least one of the valves.

### TECHNICAL FIELD

The present implementations relate generally to the field of fuel cells, and more particularly to systems and methods for a multi-input cathode loop control for fuel cells.

### BACKGROUND

Fuel cells may be used to generate/supply electrical power in various use cases and applications. In some implementations, fuel cells may be provided as an energy source for various machinery. Such fuel cells may include proton exchange membrane (PEM) fuel cells. In a PEM fuel cell, hydrogen may be supplied to an anode loop, and oxygen may be supplied to the cathode loop. Such fuel systems may include various solutions which regulate the amount of air supplied to the cathode loop, to prevent over/under saturation.

For example, U.S. Patent Application Publication No. 2017/0054166 describes a fuel cell system, including a fuel cell which has a cathode input and a cathode output. A cathode supply path is situated upstream from the cathode input and connected thereto, and a cathode exhaust gas path is situated downstream from the cathode output and connected thereto. A conveying means is situated in the cathode supply path for conveying a cathode gas flow into the cathode input and/or an adjustable exhaust gas throttle means, which is situated in the cathode exhaust gas path, for influencing a flow resistance of the cathode exhaust gas path. A regulating device is configured to regulate the cathode gas flow (GS_K) and/or a cathode pressure (p_K).

### SUMMARY

A first aspect provided herein relates to a fuel cell system including a turbo compressor, arranged to supply intake air, as pressurized airflow to a cathode loop of a fuel cell. The fuel cell system may include one or more valves arranged to manage a pressure of at least one of the pressurized airflow or an exhaust pressure of the fuel cell. The fuel cell system may include a controller configured to determine, based on at least on a current demand, a target inlet mass flow and a corresponding pressure ratio of the turbo compressor. The controller may be configured to determine, based on the inlet mass flow and the pressure ratio, a desired turbo speed of the turbo compressor. The controller may be configured to generate a first drive signal for the turbo compressor, to drive the turbo compressor at the desired turbo speed. As the turbo compressor is driven at the desired turbo speed, the controller may be configured to determine, based on sensor data of one or more sensors, an actual inlet mass flow and one or more pressure values relating to the turbo compressor. The controller may be configured to generate, based on the actual inlet mass flow and the one or more pressure values, one or more valve control signals for driving at least one of the one or more valves, to modify an operating condition of the fuel cell system. The controller may be configured to generate one or more second drive signals for the turbo compressor, based on the modified operating condition responsive to driving the at least one of the one or more valves.

A second aspect provided herein relates to a method. The method may include determining, by one or more processors, based on at least on a current demand, a target inlet mass flow and a corresponding pressure ratio of a turbo compressor of a fuel cell system. The method may include determining, by the one or more processors, based on the inlet mass flow and the pressure ratio, a desired turbo speed of the turbo compressor. The method may include generating, by the one or more processors, a first drive signal for the turbo compressor, to drive the turbo compressor at the desired turbo speed. As the turbo compressor is driven at the desired turbo speed, the method may include determining, by the one or more processors based on sensor data of one or more sensors, an actual inlet mass flow and one or more pressure values relating to the turbo compressor. The method may include generating, based on the actual inlet mass flow and the one or more pressure values, one or more valve control signals for driving one or more valves, to modify an operating condition of the fuel cell system. The method may include generating, by the one or more processors, one or more second drive signals for the turbo compressor, based on the modified operating condition responsive to driving the at least one of the one or more valves.

A third aspect provided herein relates to a controller for a fuel cell. The controller includes one or more processors. The one or more processors are configured to determine, based on at least on a current demand, a target inlet mass flow and a corresponding pressure ratio of a turbo compressor of the fuel cell system. The processor(s) are configured to determine, based on the inlet mass flow and the pressure ratio, a desired turbo speed of the turbo compressor. The processor(s) are configured to generate a first drive signal for the turbo compressor, to drive the turbo compressor at the desired turbo speed. As the turbo compressor is driven at the desired turbo speed, the processor(s) are configured to determine, based on sensor data of one or more sensors, an actual inlet mass flow and one or more pressure values relating to the turbo compressor. The processor(s) are configured to generate, based on the actual inlet mass flow and the one or more pressure values, one or more valve control signals for driving one or more valves, to modify an operating condition of the fuel cell system. The processor(s) are configured to generate one or more second drive signals for the turbo compressor, based on the modified operating condition responsive to driving the at least one of the one or more valves.

### BRIEF DESCRIPTION OF THE DRAWINGS

FIG. 1 is a block diagram of a fuel cell system for multi-input anode loop control for fuel cells, in accordance with present implementations.

FIG. 2 is a block diagram of the fuel cell system, in accordance with present implementations.

FIG. 3 is a control diagram for controlling the turbo compressor and valves of the fuel cell system, in accordance with present implementations.

FIGS. 4A-4C are flowchart of methods for controlling the multi-input cathode loop, in accordance with present implementations.

FIG. 5 is a flowchart showing a method for the multi-input cathode loop control for fuel cells, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to implement multi-input loop control for fuel cells to providing an adequate amount of Oxygen to the fuel cell. Fuel cells typically vary in demands for oxygen based on the type of fuel cell, efficiency of the cell, and the electrical power output needed. To calculate the demand, the fuels cells operate based on a stoichiometric ratio to indicate a specific amount of hydrogen from an anode that needs to interact with oxygen (or air) at the cathode in the fuel cell. In a Proton Exchange Membrane (PEM), the reaction between hydrogen and oxygen is represented as

$$2 {H}_{2} + {O}_{2} {\to }^{yields} 2 {H}_{2} O .$$

Various components of the fuel cell (e.g., turbo compressor, bypass valve) can control the supply of oxygen to the cathode loop. However, inefficient use of the components can result in inefficient use of hydrogen supplied to the anode loop (e.g., by providing excess or insufficient oxygen), thus resulting in decreased efficiency of the fuel cell.

According to the systems and methods described herein, a cathode controller can use one or more models which execute in real-time to calculate the desired set points and a feedback loop to maintain the setpoint. The cathode controller may control the turbo speed (or turbo drive speed/drive speed) as a primary parameter for regulating both airflow and boost control. The cathode controller may compute or otherwise determine the turbo speed by calculating cathode airflow using the one or more models and a desired stoichiometry airflow. The fuel cell system may include one or more valves (such as a backpressure valve and/or bypass valve) to tune the desired airflow as the turbo compressor gets up to speed. The centralized nature of the model-based set point calculation and bandwidth separation of different loops ensures smooth handoff and transients. The cathode controller may control a bypass valve, by monitoring various operating conditions for the fuel cell system, to protect against turbo compressor surge. The cathode controller can be adapted to different applications and use cases by modification of the model(s) in the controller design.

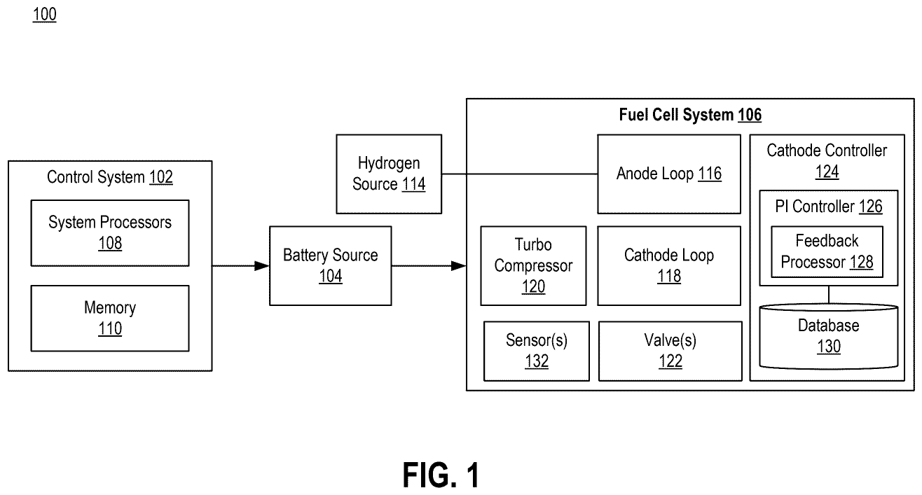

FIG. 1 is a block diagram of a system 100 for multi-input cathode loop control for fuel cells. The system 100 may include at least one control system 102 communicably coupled to a fuel cell system 106 through a battery source 104. The control system 102 may be implemented in various environments or systems. For example, the control system 102 may be implemented in various vehicles or machinery for supplying power to the vehicle/machine(s), as a power generation system for homes or businesses (e.g., primary or back-up power), etc. In some embodiments, the control system 102 may be implemented in various heavy machinery components or vehicles to supply power thereto.

The control system 102 may include one or more system processors 108 (generally referred to as a “processor 108” or as “processors 108”) and memory 110. The processors 108 may be or include any device, component, element, or hardware designed or configured to perform the various steps recited herein. For example, the processors 108 may include any number of general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 108 designed or configured to perform each of the various steps recited herein.

In some embodiments, the control system 102 may include multiple processors 108 which are designed or configured perform (e.g., either separately or together) each of the various steps recited herein. As one example, the control system 102 may include a first processor 108 designed or configured to perform a first subset of the various steps, and a second processor 108 designed or configured to perform a second subset of the various steps (with the first subset being different from the second subset). As another example, the control system 102 may include first and second processors 108 which together perform the various steps in a distributed fashion. As such, unless explicitly indicated otherwise, such as by use of a term such as “a single processor”, the term “one or more processors” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 110 may be or include any type or form of data storage device, including tangible, non-transient volatile memory and/or non-volatile memory.

The battery source 104 may be an external battery source separate from electrical components within the fuel cell system 106 or the anode controller 126. The battery source 104 may provide, supply, or otherwise electrical energy to the various components of the fuel cell system 106. The control system 102 may trigger or cause the battery source 104 to supply power to the vehicle or the heavy machinery. In some embodiments, the battery source 104 may be implemented within the various heavy machinery to supply electrical power thereto.

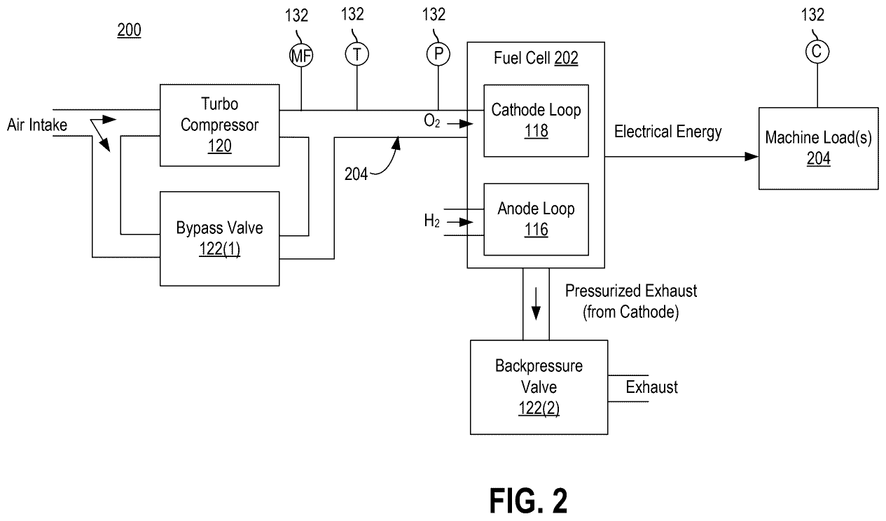

Referring now to FIG. 1 and FIG. 2, FIG. 2 is a block diagram 200 of the fuel cell system 106. The fuel cell system 106 may include a fuel cell 202 including an anode loop 116 which receives hydrogen supplied from a hydrogen source 114, and a cathode loop 118 which receives pressurized/compressed airflow from a turbo compressor 120. The hydrogen source 114 supplies pressurized hydrogen to a proton exchange membrane (PEM) (e.g., an anode loop 116 of a PEM fuel cell 202 corresponding to the fuel cell system 106). In some embodiments, the turbo compressor 120 intakes air (e.g., ambient air) and compresses/pressurizes the intake air as pressurized airflow supplied to the cathode loop 118. Using hydrogen supplied to the anode loop 116 and oxygen from the cathode loop 118, the fuel cell 202 may produce electrical energy (e.g., for one or more machine load(s) 204) and heat for one or more fuel cells 202. For example, the fuel cell 202 may generate or produce electrical energy by splitting the hydrogen of the anode loop 116 into protons and electrons, whereas the oxygen of the cathode loop 118 may combine with the protons and electrons to produce electricity and water, with heat generated as a byproduct.

In some embodiments, the fuel cell system 106 may include one or more valves 122. The valves may be fluidically coupled and/or arranged within the fuel cell system 106, to manage a pressure of the pressurized airflow (e.g., from the turbo compressor 120) and/or an exhaust pressure of the fuel cell 202. For example, the valve(s) 122 may include a bypass valve 122(1) and a backpressure valve 122(2). The bypass valve 122(1) may be arranged or situated in parallel with the turbo compressor 120. For example, an inlet of the bypass valve 122(1) may be fluidically coupled to an inlet or intake of the turbo compressor 120, and an outlet of the bypass valve 122(1) may be fluidically coupled to an outlet or output of the turbo compressor 120. The bypass valve 122(1) may be configured to manage a surge condition of the turbo compressor 120. For example, the bypass valve 122(1) may be configured to open and close, to throttle the amount of air supplied at the intake of the turbo compressor 120 to prevent a surge condition (e.g., resultant from reduced airflow at the intake side of the turbo compressor 120). The backpressure valve 122(2) may be fluidically coupled to an exhaust of the fuel cell 202 (e.g., downstream from an exhaust of the fuel cell 202). The backpressure valve 122(2) may be configured to modify the exhaust pressure of the exhaust, to tune the desired airflow as the turbo compressor 120 gets up to speed. For example, the backpressure valve 122(2) may open and close, to throttle the exhaust flow to maintain stable pressure within the cathode loop 118 (e.g., by ensuring that the exhaust pressure is neither too high, which can cause mechanical stress, nor too low, which can reduce efficiency of the oxygen-side reactions).

The fuel cell system 106 may include sensors 132. The sensors 132 may be arranged or provided at various points in the fuel cell system 106, to measure, sense, quantify, detect, or otherwise determine various operating conditions of the fuel cell system 106. For example, the sensors 132 may include pressure sensors, mass flow sensors, temperature sensors, current or power sensors, etc. The pressure sensors 132 may be arranged or provided to determine various pressures within the fuel cell system 106 (such as at the input/output side of the turbo compressor 120, at the input/output side of the cathode loop 118, etc.). The mass flow sensors may be arranged or provided to sense or detect an actual mass flow (e.g., a volumetric or other flow of air into/through/output from the cathode loop 118). For example, the mass flow sensors may be arranged at the input of the cathode loop 118 (e.g., downstream from the turbo compressor 120), at or near the turbo compressor 120 (e.g., at an intake or output), at the output of the cathode loop 118 (e.g., at the exhaust), and so forth. The temperature sensors may be arranged or provided to sense various temperature conditions (e.g., ambient conditions, coolant temperatures, etc.). Current sensor(s) 132 (or power sensor(s)) may be arranged or configured to transmit, send, or otherwise provide the current demand of the machine (e.g., machine loads 206) to the cathode controller 124. The current demand may increase or decrease according to the load of the machine. For example, a bulldozer may carry one or more boulders in the blade. Due to the increase of weight of the bulldozer, the current demand may increase to power the bulldozer. In another example, a heavy machine may park at the end of a workday. Thus, the current demand may decrease as the heavy machine does not include a load. The target anode inlet pressure may indicate or identify the optimal anode inlet pressure described above.

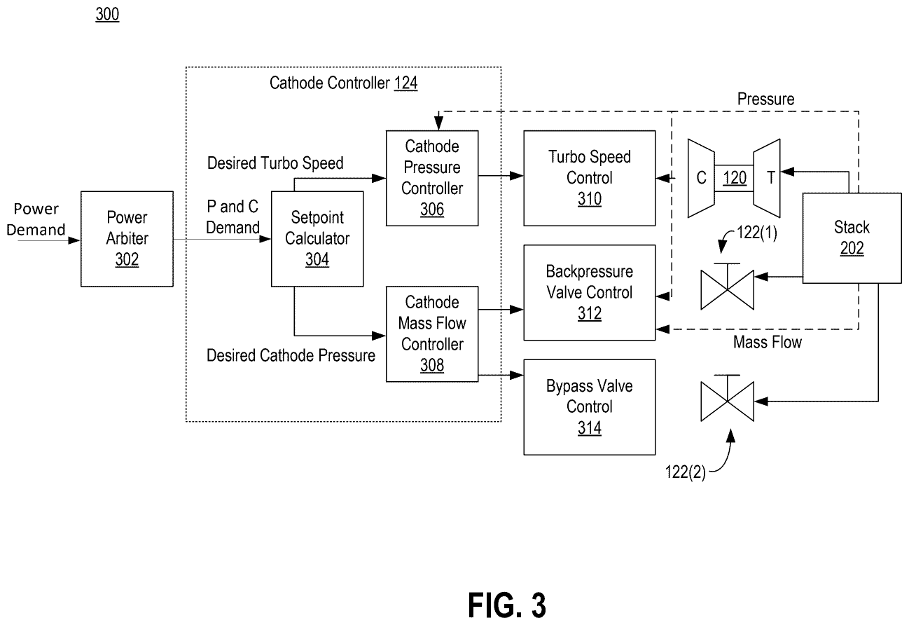

Referring to FIG. 1 and FIG. 3, depicted in FIG. 3 is a control diagram for controlling the turbo compressor 120 and valves 122. As shown in FIG. 3, a power demand value may be suppled or determined by a power arbiter 302. The power arbiter 302 may be a component of or executed by hardware of the control system 102. The power arbiter 302 may be configured to determine the power demand value based on a user input (e.g., an operator of the machine), based on operating conditions of the machine (e.g., the machine loads 204 of FIG. 2), estimated or predicted power demand based on historical usage of the machine at certain times of day or a schedule, etc. The power arbiter 302 may be configured to determine a power and current value, based on the power demand value. For example, the power arbiter 302 may be configured to determine (e.g., based on the power demand value) whether the power demand value exceeds a threshold (e.g., a maximum power demand). Where the power demand value is less than (or equal to) the threshold, the power arbiter 302 may be configured to set the power and current value based on or according to the power demand value. Where the power demand value is greater than (or equal to) the threshold, the power arbiter 302 may be configured to set the power and current value based on or according to the maximum power demand (e.g., by throttling one or more machine loads 204 to match the maximum power demand).

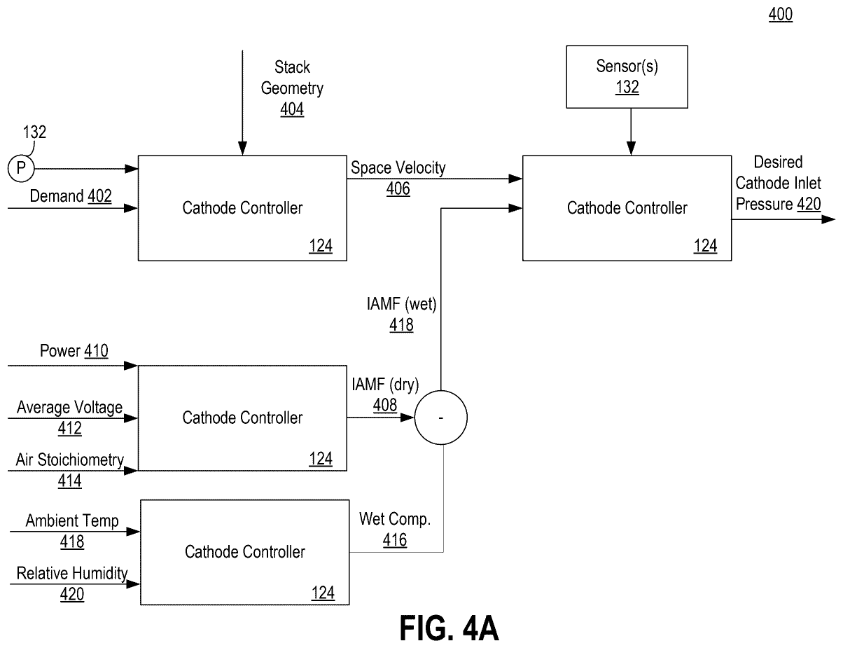

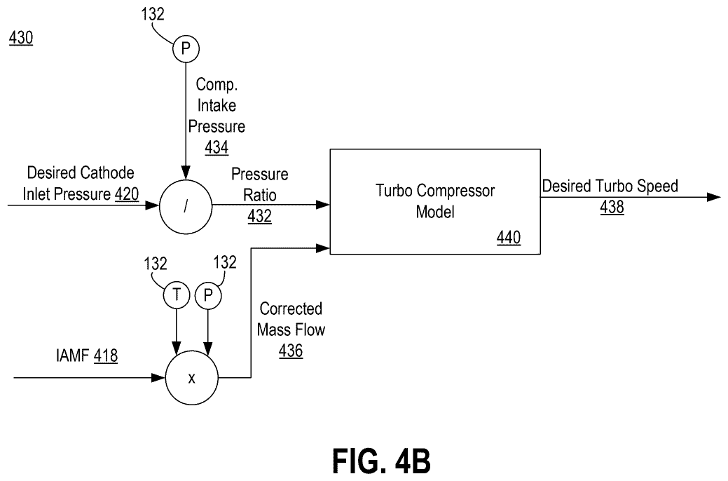

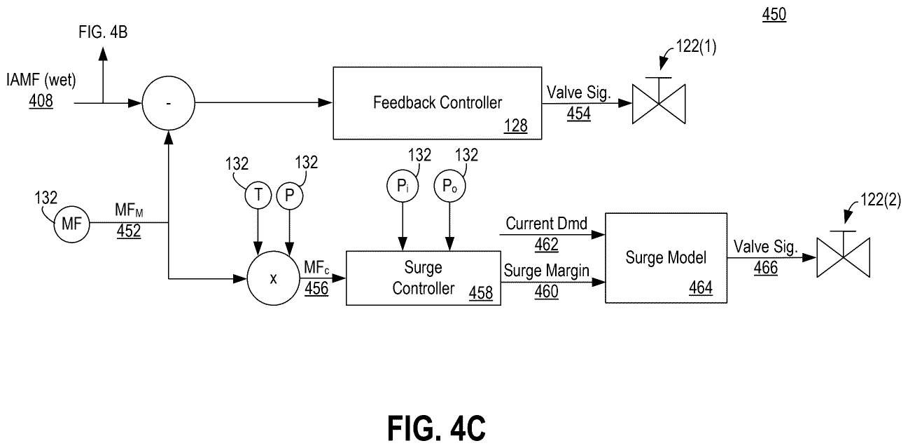

The cathode controller 124 may include general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. The cathode controller 124 may include a setpoint calculator 304, a cathode pressure controller 306, and a cathode mass flow controller 308. The setpoint calculator 304 may be configured to compute, calculate, derive, or otherwise determine one or more setpoints based on or according to the power and current demand. The setpoint calculator 304 may be configured to determine the setpoints as described below with reference to FIG. 4A-FIG. 4C. The setpoints may include a desired turbo speed (e.g., a drive speed of the turbo compressor 120) and a desired cathode pressure. The setpoint calculator 304 may be configured to supply the setpoints to the cathode pressure controller 306 and cathode mass flow controller 308. For example, the setpoint calculator 304 may be configured to provide the desired turbo speed to the cathode pressure controller 306, and provide the desired cathode pressure to the cathode mass flow controller 308. The cathode pressure controller 306 may be configured to generate, determine, or otherwise provide a turbo speed command (or drive signal) to a turbo speed control 310. The turbo speed control 310 may be a component/element/hardware of the turbo compressor 120, which uses the drive signal to control the turbo compressor 120 (e.g., drives the turbo compressor 120 according to the drive signal). Similarly, The cathode mass controller 308 may be configured to generate, determine, or otherwise provide valve control signal(s) (e.g., a current corresponding to a current signal) to corresponding valve controls (e.g., a backpressure valve control 312 and bypass control valve 314), to drive the valves 122(1), 122(2) according to the valve control signals.

Returning to FIG. 2, and in operation, based on the determined/computed setpoints, the turbo compressor 120 may draw in air (e.g., air intake) according to the bypass valve position, and compress/pressurize the air for supplying to the cathode loop 118 (e.g., as pressurized airflow). The bypass valve 122(1) may selectively open and close (e.g., according to corresponding valve control signal(s)) to throttle the amount of air supplied at the intake side of the turbo compressor (e.g., by providing a bypass route for airflow when throttling down the volumetric flow at the intake side as the bypass valve 122(1) is opened, or by increasing the volumetric flow at the intake side as the bypass valve 122(1) is closed). Similarly, the backpressure valve 122(2) may throttle the exhaust pressure (e.g., according to corresponding valve control signal(s)), to provide desired operating conditions at the cathode side of the fuel cell 202. As the turbo compressor 120 and valves 122 are controlled, the cathode controller 124 may be configured to receive various sensor data from the sensors 132, and generate additional drive/control signals to provide for steady-state operation of the fuel cell system 106.

Referring now to FIG. 4A-FIG. 4C, depicted are process flows 400, 430, and 450, respectively, of methods for controlling the multi-input cathode loop. The methods described in FIG. 4A-FIG. 4C may be executed by the cathode controller 124 described above.

Referring specifically at FIG. 4A, in the process flow 400, the cathode controller 124 may be configured to calculate, generate, compute, or otherwise determine a space velocity (SV) 406, based on or according to the current demand 402, a pressure from a pressure sensor 132 (e.g., an ambient pressure), and stack geometry 404. The SV 406 may be or include a flow rate within the space of the fuel cell system 106 (e.g., in kilograms per radius, kG/r). In parallel, the cathode controller 124 may be configured to calculate a dry inlet air mass flow (IAMF) 408 using/based on/according to the power demand 410 of the machine, the average voltage 412, and the air stoichiometry 414. For example, the cathode controller 124 may determine the IAMF 408, using the equation 1 below, where P_{c} is the power demand, V_{c} is the average voltage 310, and λ is the air stoichiometry:

$$3.57 * 1 {0}^{- 7} * λ * {P}_{c} * {V}_{c} \qquad ( 1 )$$

The cathode controller 124 may be configured to calculate, compute, or otherwise determine a wet compensation 416, based on or according to an ambient temperature 418 and relative humidity. For example, the cathode controller 124 may be configured to determine the wet compensation 416 using equation 2 below, where P_{ws} is a saturation vapor pressure, T is the temperature (in Kelvin), and A, m, and Tn are constants from Table 1 below (which may be stored in the database 130 of FIG. 1, or otherwise accessible by the cathode controller 124). The constants may be selected according to the temperature, T.

$${P}_{w s} = A \cdot 10 ( \frac{m T}{T n + T} ) \qquad ( 2 )$$

TABLE 1
Constants for Formula 2

| A | m | Tn | Max Error | Temperature Range |
|---|---|---|---|---|
| 6.089613 | 7.33502 | 230.3921 | 0.368% | 0 . . . +200° C. |
| 6.114742 | 9.778707 | 273.1466 | 0.052% | −70 . . . 0° C. |
| 6.11641 | 7.591386 | 240.7263 | 0.083% | −20 . . . +50° C. |
| 6.004918 | 7.33796 | 229.3975 | 0.0017% | +50 . . . +100° C. |
| 5.856548 | 7.27731 | 225.1033 | 0.003% | +100 . . . +150° C. |

The cathode controller 124 may combine or otherwise determine a wet compensated IAMF 418, based on or according to the dry IAMF 408 and wet compensator 416.

Responsive to determining the SV 406 and the IAMF 418, the cathode controller 124 may determine, compute, or otherwise calculate the desired cathode inlet pressure 420. For example, the cathode controller 124 may determine, compute, or otherwise calculate the desired cathode inlet pressure 420, using the equation 3 below (e.g., the ideal gas law):

$$P = \frac{m * R * T}{V} \qquad ( 3 )$$

The cathode controller 124 may receive sensor data from the sensors 132 (e.g., the pressure sensor, temperature sensor, etc.), along with the IAMF 418 and space velocity 406, to calculate the desired cathode inlet pressure 420.

Referring now to FIG. 4B, the cathode controller 124 may execute the process flow 430 to determine the desired turbo speed 438, responsive to execution of the process flow 400 of FIG. 4A. As shown in FIG. 4B, the cathode controller 124 may be configured to compute, calculate, or otherwise determine a pressure ratio 432, based on the desired cathode inlet pressure 420 (e.g., of FIG. 4A) and a sensed compressor intake pressure 434. The cathode controller 124 may be configured to receive the sensed compressor intake pressure 434 from a pressure sensor 132 arranged at the inlet of the turbo compressor 120. In parallel, the cathode controller 124 may be configured to compute, calculate, or otherwise determine a corrected mass flow 436, based on the IAMF 418 (e.g., of FIG. 4A) and one or more sensed operating conditions (e.g., including the a sensed temperature and pressure) from corresponding sensors 132.

The cathode controller 124 may be configured to determine the desired turbo speed 438 based on or according to the pressure ratio 432 and the corrected mass flow 436. In some embodiments, the cathode controller 124 may store, maintain (e.g., in the database 130) or otherwise access a turbo compressor model 440 used to determine the desired turbo speed 438 based on such inputs. For example, the turbo compressor model 440 may be three-dimensional compressor map or model of the turbo compressor 120 (e.g., mapping out geometric and space properties of the turbo compressor 120). The cathode controller 124 may be configured to apply the pressure ratio 432 and corrected mass flow 436 to the turbo compressor model 440, to identify or otherwise determine a corresponding desired turbo speed 438. Responsive to determining the desired turbo speed 438, the cathode controller 124 may be configured to generate a drive signal for the turbo compressor 120, to drive the turbo compressor 120 at the desired turbo speed 438.

Referring now to FIG. 4C, the process flow 450 may be executed in parallel with the process flow 430 of FIG. 4C. As shown in FIG. 4C, the cathode controller 124 may be configured to determine a difference between the compensated IAMF 408 (e.g., determined following execution of process flow 400) and a measured mass flow, MF_{M}, 452 based on data from a mass flow sensor 132. The cathode controller 124 may be configured to provide the difference to a feedback controller 128. The feedback controller 128 may be a feedback loop (such as a proportional and integral, PI, controller, a PI-derivative, PID, controller, or any other feedback controller). The feedback controller 128 may be configured to generate a valve control signal 454 (e.g., for the backpressure valve 122(1)), to regulate an exhaust pressure of the cathode loop 118, based on or according to the difference between the IAMF 408 and the MF_{M} 452.

In parallel, the cathode controller 124 may be configured to apply the MF_{M} 452 to a multiplier which compensates for sensed temperature and pressure (e.g., from corresponding sensors 132). The cathode controller 124 may be configured to determine a corrected mass flow, MF_{C}, 456 based on the temperature and pressure. The cathode controller 124 may include a surge controller 458 which determines a surge margin for the turbo compressor 120, based on the MF_{C} 456 and sensed pressure conditions of the turbo compressor 120 (e.g., an input pressure at the intake of the turbo compressor 120, and an output pressure at the output of the turbo compressor 120). For example, the surge controller 458 may determine, compute, or otherwise calculate the surge margin, using the equation 4 below.

$$Surge Margin = \frac{Air Flow - Surge Air}{Air Flow} \cdot 100 \qquad ( 4 )$$

The surge controller 458 may be configured to apply the surge margin to a surge model 464. The surge model 464 may be similar to the turbo compressor model 440, in that the surge model 464 may be a three-dimensional surge line map or model of the surge line (e.g., mapping out geometric and space properties of the surge line). The cathode controller 124 may be configured to maintain or otherwise access the surge model 464 in a manner similar to the turbo compressor model 440. The cathode controller 124 may be configured to apply the current demand 462 and surge margin 460 to the surge model 464, to generate a valve control signal 464 for the bypass valve 122(2), to prevent a surge condition of the turbo compressor 120.

Referring again to FIG. 4A-FIG. 4C, it is noted that each of the described process flows 400, 430, 450 may interact with one another. For example, as the turbo compressor 120 is driven up to the desired turbo speed 438, the operating conditions may change (e.g., reflected in different sensor measurements from the mass flow sensor 132, pressure sensor(s) 132, etc.). As such, the cathode controller 124 may be configured to generate valve control signals to operate the valves 122, to compensate for the change in operating conditions. Similarly, the cathode controller 124 may update the desired turbo speed as the operating conditions dynamically change. Such process flows may be iteratively executed until the fuel cell system 106 reaches steady state.

### Industrial Applicability

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells. The disclosed cathode controller 124 may be provided to optimize control of the actuators (e.g., turbo compressor 120, valves 122, etc.) within the fuel cell system 106, by simultaneously controlling the valves 122 and turbo compressor 120 to maintain peak performance of the fuel cell system 106, based on feedback according to the detected operating conditions (from sensor data of the sensors 132).

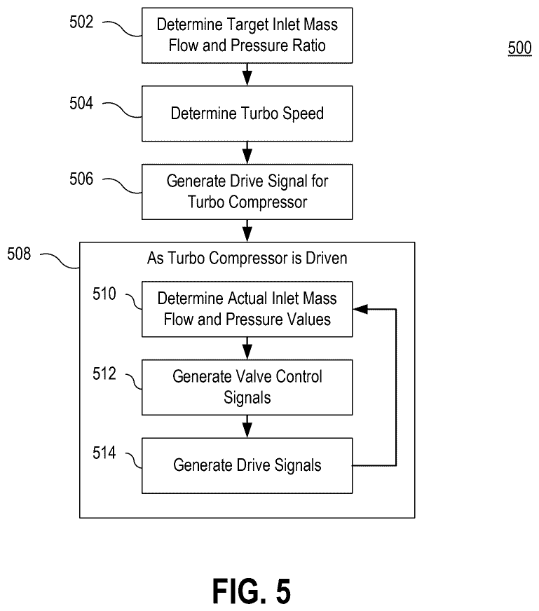

Referring now to FIG. 5, together with FIG. 4A-FIG. 4C, FIG. 5 depicts a flowchart showing an example method 500 of multi-input cathode control, according to an example implementation of the present disclosure. The method 500 may be performed or executed by the cathode controller 124 described above with reference to FIG. 1-FIG. 4C. As a brief overview, at step 502, the cathode controller 124 may determine a target inlet mass flow and pressure ratio. At step 504, the cathode controller 124 may determine a turbo speed. At step 506, the cathode controller 124 may generate a drive signal for the turbo compressor 120. While the turbo compressor 120 is driven at step 508, at step 510, the cathode controller 124 may determine an actual inlet mass flow and pressure values. At step 512, the cathode controller 124 may generate valve control signals. At step 514, the cathode controller 124 may generate drive signals.

At step 502, the cathode controller 124 may determine a target inlet mass flow and pressure ratio. In some embodiments, the cathode controller 124 may determine the target inlet mass flow 436 and a corresponding pressure ratio 432 of the turbo compressor 120. The cathode controller 124 may determine the target inlet mass flow 436 and pressure ratio 430, as a function of, based on, or according to a current demand, as illustrated in FIG. 4A and FIG. 4B. Beginning with FIG. 4B, as illustrated therein, the pressure ratio 432 may be a function of the sensed cathode inlet pressure and a desired cathode inlet pressure 420 (e.g., from FIG. 4A). Similarly, the corrected mass flow 436 may be a function of the IAMF 418 (e.g., from FIG. 4A) and various sensed conditions. Returning to FIG. 4A, the desired cathode inlet pressure 420 is determined as a function of the space velocity 406 (which in turn is determined as a function of the current demand 402). Similarly, the IAMF 418 is determined as a function of power 410. As such, the target (or corrected) inlet mass flow 436 and pressure ratio 430, may be determined based on or according to the current demand.

As illustrated in FIG. 4A, and in some embodiments, to determine the target inlet mass flow, the cathode controller 124 may determine a dry air inlet mass flow (e.g., IAMF 408). The cathode controller 124 may apply a compensation factor (e.g., wet compensation 416) based on a sensed ambient temperature and relative humidity. The cathode controller 124 may determine the IAMF 418 based on or according to the dry IAMF 408 and compensation factor. As illustrated in FIG. 4B, and in some embodiments, the cathode controller 124 may determine the corrected (e.g., target) mass flow 436, based on the IAMF 418 and sensed operating conditions of the fuel cell system.

As illustrated in FIG. 4A and FIG. 4B, and in some embodiments, to determine the pressure ratio, the cathode controller 124 may determine the inlet mass flow 418 and space velocity 406. The cathode controller 124 may determine the inlet mass flow 418 as described with reference to FIG. 4A (e.g., by determining the dry IAMF 408 and compensation factor). The cathode controller 124 may determine a space velocity 406 (e.g., of airflow) based on the ambient pressure (e.g., from pressure sensor 132) and a stack geometry of the fuel cell 202. The cathode controller 124 may determine the desired cathode inlet (or intake) pressure based on or according to the target inlet mass flow and the space velocity of airflow. In some embodiments, the cathode controller 124 may determine the pressure ratio as a function of the desired cathode inlet pressure 420 and a sensed compressor intake pressure 434 (e.g., from one or more pressure sensors 132 arranged at the intake side of the turbo compressor 120).

At step 504, the cathode controller 124 may determine a turbo speed. In some embodiments, the cathode controller 124 may determine the desired turbo speed 438, based on the inlet mass flow 436 and the pressure ratio 432. The cathode controller 124 may determine the desired turbo speed 438 by applying the inlet mass flow 436 and pressure ratio 432 to the turbo compressor model 440. At step 506, the cathode controller 124 may generate a drive signal for the turbo compressor 120. In some embodiments, the cathode controller 124 generates the drive signal to drive the turbo compressor 120 at the desired turbo speed 438.

While the turbo compressor 120 is driven at step 508, at step 510, the cathode controller 124 may determine an actual inlet mass flow and pressure values. In some embodiments, the cathode controller 124 may determine the actual inlet mass flow and pressure values relating to the turbo compressor 120, as the turbo compressor 120 speeds up to the drive speed. The cathode controller 124 may determine the actual inlet mass flow and pressure value(s) based on or according to data from various sensors 132 of the fuel cell system 106. For example, the cathode controller 124 may determine the measured mass flow MF_{M} 452, based on sensor data from the mass flow sensor 132. Similarly, the cathode controller 124 may determine pressure values relating to the turbo compressor 120, based on sensor data from pressure sensors 132 (e.g., intake/inlet pressure, Pᵢ, and output/outlet pressure, Pₒ) arranged to sense operating pressures of the turbo compressor 120.

At step 512, the cathode controller 124 may generate valve control signals. In some embodiments, the cathode controller 124 may generate one or more valve control signals for driving one or more valves 122, to modify an operating condition of the fuel cell system 106. The cathode controller 124 may generate the valve control signal(s) based on or according to the actual inlet mass flow MF_{M} 452 (or MF_{C} 455) and/or the one or more pressure values (Pᵢ and/or Pₒ). The cathode controller 124 may generate the valve control signal(s) for the backpressure valve 122(1) and/or for the bypass valve 122(2). In some embodiments, the cathode controller 124 (e.g., the feedback controller 128 of the cathode controller 124) may execute a feedback loop which generates the one or more valve control signals, based on the target inlet air mass flow and a sensed inlet air mass flow as the actual inlet mass flow.

At step 514, the cathode controller 124 may generate drive signals. In some embodiments, cathode controller 124 may generate subsequent drive signal(s) for the turbo compressor 120, based on the modified operating condition responsive to driving various combinations of the valves 122. For example, the cathode controller 124 may generate additional or subsequent drive signal(s) for the turbo compressor 120 (e.g., to speed up or slow down driving of the turbo compressor 120) based on various sensed operating conditions. Similarly, the cathode controller 124 may generate additional valve control signal(s) (e.g., to open/close/throttle the backpressure valve 122(1) and/or bypass valve 122(2)) based on various sensed operating conditions. In this regard, the method 500 may iteratively loop between steps 510-514, until the operating condition of the fuel cell system 106 satisfies an operating criteria corresponding to the current demand (e.g., until the fuel cell system 106 is driven in a manner which produces power according to the current demand).

According to the systems and methods described herein, the cathode controller 124 implements a hybrid MIMO (multi-input, multi-output) loop which uses various models (e.g., computational models as well as a turbo compressor model 440 and/or surge model 464) for computing setpoints in real-time. The cathode controller 124 may execute in real-time using sensed operating conditions, and execute a feedback loop (e.g., a simple closed loop feedback controller 128) to maintain the desired setpoint. The cathode controller 124 may primarily control the desired turbo speed 438 as the primary control parameter for both airflow and boost control. The cathode controller 124 may compute the desired turbo speed as a function of the cathode airflow (e.g., cathode inlet pressure 420), which is a function of the equations described above and desired stoichiometry airflow. The cathode controller 124 may control the backpressure valve 122(1) (when present) as a secondary loop for tuning the desired airflow as the turbo compressor 120 gets up to speed. The centralized nature of the cathode controller 124 used for set point calculation and bandwidth separation of different loops, ensures smooth handoff and transients. The cathode controller 124 may monitor various operating conditions of the turbo compressor 120, and control the bypass valve 122(2) to protect against turbo compressor surge. The cathode controller 124 can be adapted to different stacks and deployments (in various implementations and use cases) by modifying the various models and computations described herein. As such, the cathode controller 124 provides an adaptable solution which accommodates for different deployments in different types of machines.

What is claimed is:

1. A fuel cell system, comprising:
a turbo compressor, arranged to supply intake air, as pressurized airflow to a cathode loop of a fuel cell;
one or more valves arranged to manage a pressure of at least one of the pressurized airflow or an exhaust pressure of the fuel cell; and
a controller configured to:
determine, based on at least on a current demand, a target inlet mass flow and a corresponding pressure ratio of the turbo compressor;
determine, based on the inlet mass flow and the pressure ratio, a desired turbo speed of the turbo compressor;
generate a first drive signal for the turbo compressor, to drive the turbo compressor at the desired turbo speed; and
as the turbo compressor is driven at the desired turbo speed,
determine, based on sensor data of one or more sensors, an actual inlet mass flow and one or more pressure values relating to the turbo compressor;
generate, based on the actual inlet mass flow and the one or more pressure values, one or more valve control signals for driving at least one of the one or more valves, to modify an operating condition of the fuel cell system; and
generate one or more second drive signals for the turbo compressor, based on the modified operating condition responsive to driving the at least one of the one or more valves.

2. The fuel cell system of claim 1, wherein the one or more valves comprise at least one of:
a bypass valve, arranged in parallel with the turbo compressor, configured to manage a surge condition of the turbo compressor; or
a backpressure valve, arranged downstream from an exhaust of the fuel cell, configured to modify an exhaust pressure of the exhaust.

3. The fuel cell system of claim 2, wherein the one or more valves comprise each of the bypass valve and the backpressure valve.

4. The fuel cell system of claim 1, wherein, to determine the target inlet mass flow, the controller is configured to:
determine, based on the current demand, average voltage, and a weighted value, a dry air inlet mass flow; and
apply, based on a sensed ambient temperature and sensed relative humidity, a compensation factor for applying to the dry air inlet mass flow, to determine the target inlet mass flow.

5. The fuel cell system of claim 1, wherein, to determine the pressure ratio, the controller is configured to:
determine the target inlet mass flow;
determine, based on an ambient pressure and stack geometry, a space velocity of airflow; and
determine, based on the target inlet mass flow and the space velocity of airflow, a desired cathode inlet pressure.

6. The fuel cell system of claim 5, wherein the pressure ratio is determined as a function of the desired cathode inlet pressure and a sensed compressor intake pressure.

7. The fuel cell system of claim 1, wherein the controller is configured to execute a feedback loop which generates the one or more valve control signals, based on the target inlet air mass flow and a sensed inlet air mass flow as the actual inlet mass flow.

8. The fuel cell system of claim 1, wherein the controller is configured to generate the one or more valve control signals, based on an inlet pressure and an outlet pressure of the turbo compressor.

9. The fuel cell system of claim 1, wherein the controller is configured to iteratively generate the one or more control signals and the one or more second drive signals, until the operating condition of the fuel cell satisfies an operating criteria corresponding to the current demand.

10. The fuel cell system of claim 1, wherein to generate the one or more second drive signals for the turbo compressor, the controller is configured to:
determine, responsive to driving the at least one of the one or more valves, the modified operating condition of the fuel cell system;
determine a second desired target drive speed for the turbo compressor, based on the modified operating condition; and
generate the one or more second drive signals for the turbo compressor, according to the second desired target drive speed.

11. A method, comprising:
determining, by one or more processors, based on at least on a current demand, a target inlet mass flow and a corresponding pressure ratio of a turbo compressor of a fuel cell system;
determining, by the one or more processors, based on the inlet mass flow and the pressure ratio, a desired turbo speed of the turbo compressor;
generating, by the one or more processors, a first drive signal for the turbo compressor, to drive the turbo compressor at the desired turbo speed;
as the turbo compressor is driven at the desired turbo speed,
determining, by the one or more processors based on sensor data of one or more sensors, an actual inlet mass flow and one or more pressure values relating to the turbo compressor;
generating, based on the actual inlet mass flow and the one or more pressure values, one or more valve control signals for driving one or more valves, to modify an operating condition of the fuel cell system; and
generating, by the one or more processors, one or more second drive signals for the turbo compressor, based on the modified operating condition responsive to driving the at least one of the one or more valves.

12. The method of claim 11, wherein the one or more valves comprise at least one of:
a bypass valve, arranged in parallel with the turbo compressor, configured to manage a surge condition of the turbo compressor; or
a backpressure valve, arranged downstream from an exhaust of a fuel cell of the fuel cell system, configured to modify an exhaust pressure of the exhaust.

13. The method of claim 12, wherein the one or more valves comprise each of the bypass valve and the backpressure valve.

14. The method of claim 11, wherein determining the target inlet mass flow comprises:
determining, based on the current demand, average voltage, and a weighted value, a dry air inlet mass flow; and
applying, based on a sensed ambient temperature and sensed relative humidity, a compensation factor for applying to the dry air inlet mass flow, to determine the target inlet mass flow.

15. The method of claim 11, wherein determining the pressure ratio comprises:
determining the target inlet mass flow;
determining, based on an ambient pressure and stack geometry, a space velocity of airflow; and
determining, based on the target inlet mass flow and the space velocity of airflow, a desired cathode inlet pressure.

16. The method of claim 15, wherein the pressure ratio is determined as a function of the desired cathode inlet pressure and a sensed compressor intake pressure.

17. The method of claim 11, wherein generating the one or more valve control signals comprises executing a feedback loop which generates the one or more valve control signals, based on the target inlet air mass flow and a sensed inlet air mass flow as the actual inlet mass flow.

18. The method of claim 11, wherein the one or more valve control signals are generated, based on an inlet pressure and an outlet pressure of the turbo compressor.

19. The method of claim 11, comprising iteratively generating the one or more valve control signals and the one or more second drive signals, until the operating condition of the fuel cell system satisfies an operating criteria corresponding to the current demand.

20. A controller for a fuel cell system, the controller comprising:
one or more processors configured to:
determine, based on at least on a current demand, a target inlet mass flow and a corresponding pressure ratio of a turbo compressor of the fuel cell system;
determine, based on the inlet mass flow and the pressure ratio, a desired turbo speed of the turbo compressor;
generate a first drive signal for the turbo compressor, to drive the turbo compressor at the desired turbo speed; and
as the turbo compressor is driven at the desired turbo speed,
determine, based on sensor data of one or more sensors, an actual inlet mass flow and one or more pressure values relating to the turbo compressor;
generate, based on the actual inlet mass flow and the one or more pressure values, one or more valve control signals for driving one or more valves, to modify an operating condition of the fuel cell system; and
generate one or more second drive signals for the turbo compressor, based on the modified operating condition responsive to driving the at least one of the one or more valves.
